(19) United States
(12) Patent Application Publication
(10) Pub. No.: US 2012/0320276 A1
(43) Pub. Date: Dec. 20, 2012

(54) ANALOG VIDEO SIGNAL TRANSMISSION DEVICE

(76) Inventors: Wen-Jing Lin, Taoyuan County (TW); Chi-Hwei Hu, Taoyuan County (TW)

(21) Appl. No.: 13/418,350

(22) Filed: Mar. 13, 2012

(30) Foreign Application Priority Data
Jun. 20, 2011 (TW) 100121544

(51) Int. Cl. H04N 5/38

(52) U.S. Cl. 348/723; 348/E05.093

(57) ABSTRACT

An analog video signal transmission device includes an output unit and a receiving unit. One end of an output circuit of the output unit connects to a ground circuit, and another end outputs an analog video voltage signal to a current converter in order to convert the analog video voltage signal to a proportional analog video current signal as an output signal. A receiving unit uses a receiving circuit to receive the analog video current signal and convert it to a received analog video voltage signal. The ground circuit is a signal transmission circuit connected from a node to the receiving circuit via an impedance, and for removing ground noises.

### BACKGROUND OF THE INVENTION

1. Field of the Invention

The invention relates to an analog video signal transmission device, and more particularly, to an analog video signal transmission device for improving transmission quality of analog signals.

2. Description of the Prior Art

As the communication and multi-media develops rapidly, the requirement for the video quality becomes much higher. Reducing interference by reducing noises is an important method to improve the video quality.

FIG. 1 is a diagram of a conventional analog video signal transmission circuit of prior art. One end of the output circuit 11 in the output unit 10 is connected to ground, and another end of the output circuit 11 outputs an analog video voltage signal Vo=A(t) to a receiving unit 12. After the receiving unit 12 receives the analog video voltage signal Vo=A(t), a receiving circuit 13 of the receiving unit 12 will generate a corresponding received analog video voltage signal Vi=A(t). However, when the ground circuit G generates a ground noise N(t), it will be transmitted to the receiving unit 12 and generate the noise of the received analog video voltage signal, and affect quality of voltage signal transmission. Thus, the prior art adds an impedance Z in the receiving unit 12 to reduce interference of the ground circuit G to the receiving unit 12.

However, when the ground circuit G of the prior art generates the ground noise N(t), the ground noise N(t) will still interferes the receiving circuit 13 via the receiving circuit 13, to make the receiving circuit 13 receive the received analog video voltage signal Vi=A(t)−N(t). Tha analog signal transmission quality can not be improved due to the ground noise N(t). Thus, the conventional analog video signal transmission circuit of the prior art still has problems in removing noises.

### SUMMARY OF THE INVENTION

One objective of the present invention is to provide an analog video signal transmission device, which can convert an analog video voltage signal to an analog video current signal by a current converter to remove ground noises, to improve transmission quality of analog signals.

Another objective of the present invention is to provide an analog video signal transmission device, which can improve transmission quality of analog signals by a simple circuit without increasing wires and costs.

To achieve the abovementioned objectives, the analog video signal transmission device comprises: an output unit, having an output circuit, one end of the output circuit connected to a ground circuit, and another end outputting an analog video voltage signal to a current converter in order to convert the analog video voltage signal to a proportional analog video current signal as an output signal; and a receiving unit, using a receiving circuit to receive the analog video current signal and convert it to a received analog video voltage signal. The ground circuit is a signal transmission circuit connected from a node to the receiving circuit via an impedance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional analog video signal transmission circuit of prior art.

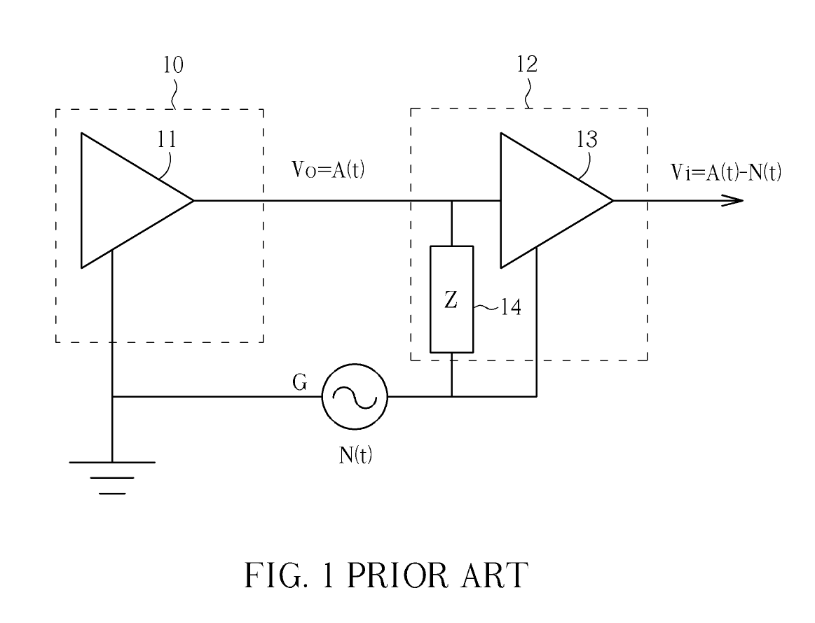

FIG. 2 is a diagram of an analog video signal transmission device of the present invention.

### DETAILED DESCRIPTION

In order to achieve the abovementioned objectives of the present invention, the adopted technical means and effects are described below by illustrating embodiments with drawings.

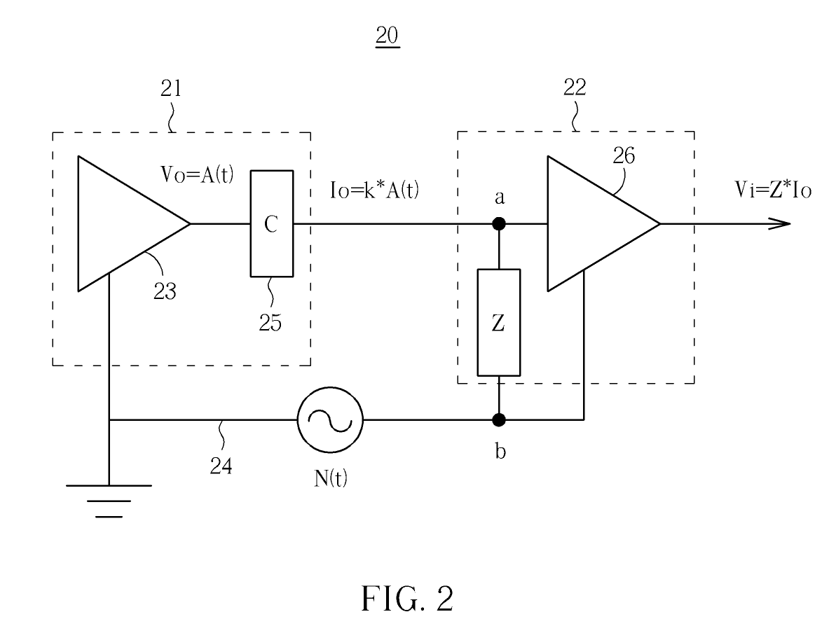

Please refer to FIG. 2 showing a diagram of an analog video signal transmission device of the present invention. The analog video signal transmission device 20 comprises an output unit 21 and a receiving unit 22. The output unit 21 can be a video device for outputting analog signals, such as an optical disk player. One end of the output circuit 23 in the output unit 21 is connected to a ground circuit 24, and another end of the output circuit 23 outputs an analog video voltage signal Vo=A(t) to a current converter 25. The current converter 25 is utilized for converting the analog video voltage signal Vo to a proportional analog video current signal Io as an output signal. The receiving unit 22 is a display device for receiving analog signals, such as a displayer or a TV. The receiving unit 22 uses a receiving circuit 26 to receive the analog video current signal Io outputted by the output unit 21 and convert it to a received analog video voltage signal Vi. A signal transmission circuit is connected from a node a in front of the receiving circuit 26 to a node b of a ground circuit 24 via an impedance Z (which is about 75 hm in general), and the ground circuit 24 is connected to the receiving circuit 26 via the node b to make the receiving circuit 26 connected to ground, so as to form the analog video signal transmission device of the present invention.

The analog video voltage signal Vo=A(t) outputted by the output circuit 23 of the output unit 21 can be converted by the current converter 25 to a proportional analog video current signal Io=k*A(t), wherein k is a proportional constant. The proportional analog video current signal Io is transmitted by the signal transmission circuit between the output unit 21 and the receiving unit 22. Since voltage of the signal transmission circuit and the ground circuit 24 is balanced at the node a, if the ground circuit 24 has noises, then the node b generates a noise voltage N(t), and the voltage at node a is Io*Z+N(t) by adding the voltage of the impedance Z. This is also the voltage received by the receiving circuit 26. However, since the receiving circuit 26 is further affected by the noise voltage N(t) of the ground circuit 24, the receiving circuit 26 finally receives an analog video voltage signal Vi=[Io*Z+N(t)]−N(t)=Io*Z, which is a voltage difference between the node a and the node b. Thus, after the current converter 25 is added to convert the analog video voltage signal to a proportional analog video current signal, the analog video voltage signal received by the receiving unit 22 will have no relation to the noise voltage N(t) of the ground circuit 24, so as to prevent the ground circuit 24 from affecting the analog video voltage signal transmission.

Thus, by adding a current converter to the conventional analog video signal transmission circuit, the analog video signal transmission device of the present invention can use a simple circuit without increasing wires and costs to convert an analog video voltage signal outputted by an output device to a proportional analog video current signal as a transmission signal, so as to remove ground noises and improve transmission quality of analog signals in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An analog video signal transmission device, comprising:
an output unit, having an output circuit, one end of the output circuit connected to a ground circuit, and another end outputting an analog video voltage signal to a current converter in order to convert the analog video voltage signal to an analog video current signal as an output signal; and
a receiving unit, using a receiving circuit to receive the analog video current signal and convert it to a received analog video voltage signal;
wherein the ground circuit is a signal transmission circuit connected from a node to the receiving circuit via an impedance.

2. The analog video signal transmission device of claim 1, wherein the output unit is a video device for outputting analog signals.

3. The analog video signal transmission device of claim 1, wherein the receiving unit is a display device for receiving analog signals.

4. The analog video signal transmission device of claim 1, wherein the current converter converts the analog video voltage signal to a proportional analog video current signal.

5. The analog video signal transmission device of claim 1, wherein the analog video current signal received by the receiving circuit is a voltage difference between the signal transmission circuit and the node.
